(19) United States
(12) Patent Application Publication
(10) Pub. No.: US 2003/0019968 A1
(43) Pub. Date: Jan. 30, 2003

(54) Magnetic tape apparatus

(75) Inventor: Takashi Masuda, Yonezawa-shi (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/201,269

(22) Filed: Jul. 24, 2002

(30) Foreign Application Priority Data
Jul. 26, 2001 (JP) 2001-226162

(51) Int. Cl. G03B 1/58

(52) U.S. Cl. 242/332.4

(57) ABSTRACT

A magnetic tape apparatus according to the present invention has a reel and a motor. A tape is wound on the reel. The motor rotates the reel. A drive arm is disposed on the reel. A follower arm is disposed on the drive arm. The follower arm has a rotatable leader block. The leader block also has a notch for hooking a pin of the tape. As a load motor is rotated, a loader is moved. The loader places a tape cartridge that is inserted from the outside at a predetermined position of a base. At that point, a motive power of the load motor is transferred to a capture gear. A capture that rotates the leader block is connected to the capture gear.

### BACKGROUND OF THE INVENTION

1. Field of the Invention

The present invention relates to a magnetic tape apparatus that performs magnetic recording/reproducing operations using a tape cartridge that contains a magnetic tape.

2. Description of the Related Art

Conventionally, in a magnetic tape apparatus that uses a tape cartridge containing a magnetic tape, unless the motive power for pulling out the magnetic tape from the tape cartridge is obtained from a reel motor, the structure becomes complicated.

For example, Japanese Patent Publication No.2001-135003 discloses a mechanism that uses a load motor as a motive power source. FIG. 1 shows the structure of the mechanism. The load motor rotates a gear 111 in a direction B. A groove 122 of the gear 111 causes a boss 121 disposed on a tray 103 to be moved in a direction D. As a result, the tray 103 is moved. A gear 112 connected to the gear 111 is rotated in a direction C. A boss 123 disposed on an arm 131 is moved along a groove 124. When the boss 123 reaches a portion 125, as a boss 126 is moved along a groove 127, a leader block 133 disposed at a tip of the arm 131 is moved.

Japanese Patent Publication No.1994-168524 discloses a magnetic tape apparatus as another structure that has a similar effect as the present invention. FIG. 3 shows the structure of the magnetic tape apparatus. A machine reel 204 has a threading arm mechanism 203 that is rotatable. As the machine reel 204 is rotated, a threading arm pin 208 disposed at a tip of the arm mechanism 203 pulls out a leader block 202 at a tip of the tape from a cartridge 201. A guide groove 205A formed in a guide plate 205 guides the threading arm mechanism 203. A spring 203D disposed in the threading arm mechanism 203 causes the leader block 202 to be placed at the center of the rotation of the machine reel 204 through a refuge groove 204A.

However, the structure disclosed in Japanese Patent Publication No.2001-135003 has the following problems. As a first problem, since the gear 112 and the grooved plate 134 are required above the arm 131, such a structure does not satisfy the requirement for reducing the size of the apparatus.

As a second problem, as shown in FIGS. 2, the arm 131 requires the boss 123 and the boss 126, the structure of the arm 131 becomes complicated. Thus, the number of parts necessary for the apparatus becomes large.

As a third problem, since the loader and the arm are driven by the same motor, a high power motor is necessary for it, so that the cost of the apparatus will increase. In other words, when the mechanism of which the tape is pulled out to the reel by the motive power of the load motor, the required torque becomes large. As a result, a special load motor is required.

As a fourth problem, since gears are used, it takes a long time until the operation of the arm is completed. Thus, it takes a long time after the cartridge is inserted into the apparatus until data is accessed.

On the other hand, the structure disclosed in Japanese Patent Publication No.1994-168524 has the following problems. As a first problem, since the threading arm structure has a spring and a guide plate disposed thereabove, such a structure does not satisfy the requirement for reducing the thickness of the apparatus.

As a second problem, since the threading arm structure is moved along the guide groove being pressured by the spring, the guide groove is abraded. Thus, the reliability of the apparatus deteriorates in a long time operation.

### SUMMARY OF THE INVENTION

Therefore, an object of the present invention is to provide a magnetic tape apparatus that uses a tape cartridge containing a magnetic tape in a simple structure in which the tape is pulled out from the cartridge using a motive power source of a reel motor that winds the tape.

The present invention is a magnetic tape apparatus for performing magnetic recording and reproducing operations using a tape cartridge containing a magnetic tape having a lead pin disposed at a tip thereof, the apparatus comprising a reel around which the tape is wound, a motor for rotating the reel, a drive arm disposed on the reel, a follower arm rotatably disposed at a tip of the drive arm, and a leader block rotatably disposed on the follower arm, the leader block having a notch for hooking the pin.

In the forgoing structure, the arm can pull out the tape using the same motive power source as the reel motor that rotates the reel. In addition, the reel can support the arm.

These and other objects, features and advantages of the present invention will become more apparent in light of the following detailed description of a preferred embodiment thereof, as illustrated in the accompanying drawings.

### BRIEF DESCRIPTION OF DRAWINGS

FIG. 1 is a plane view showing the structure of which a load motor is used as a motive power source according to the prior art reference (No.2001-135003);

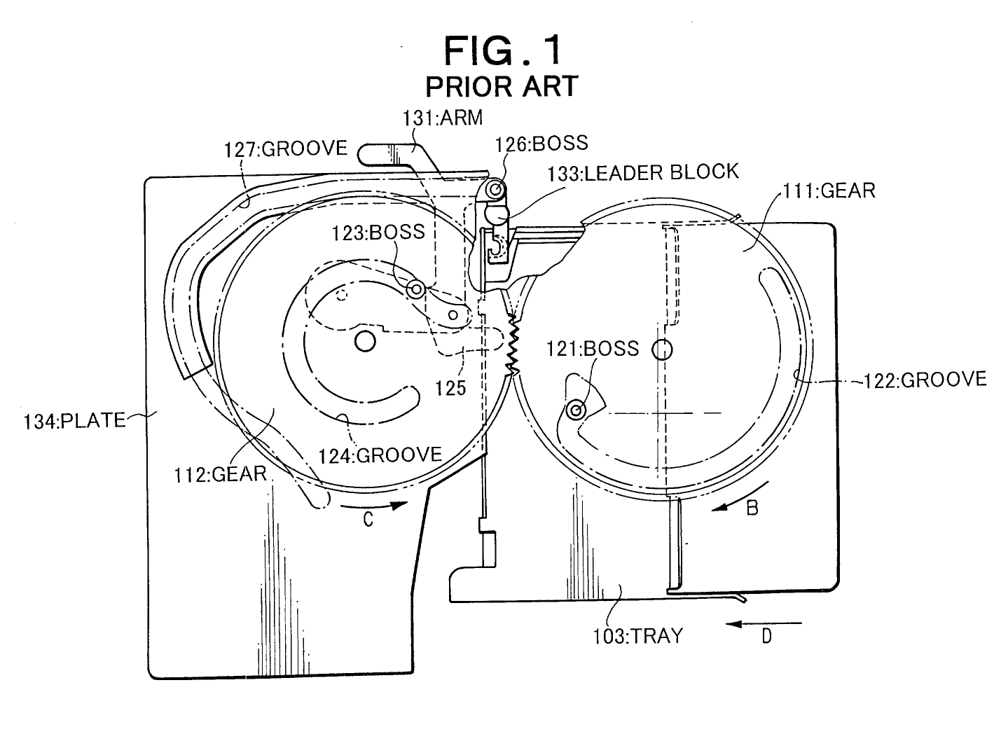

FIG. 2 is a perspective view showing the structure of an arm shown in FIG. 1;

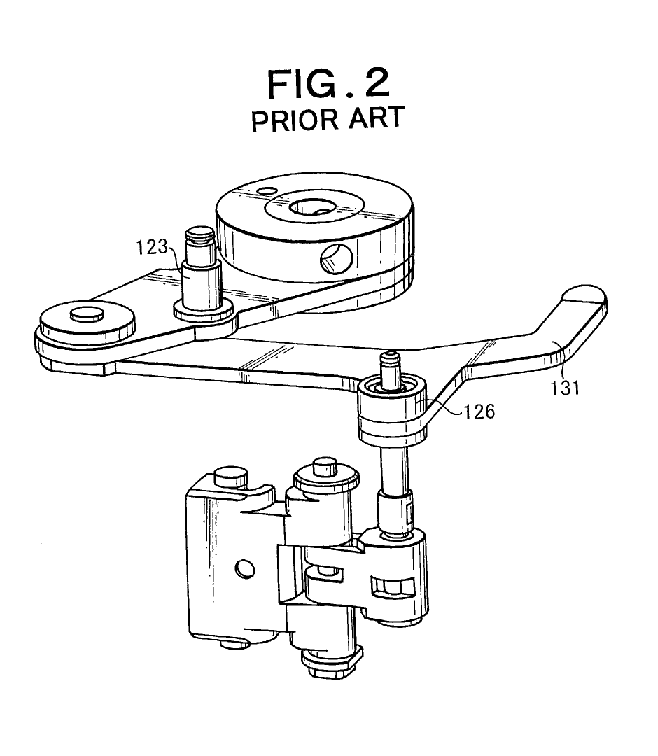

FIGS. 3A and 3B are a plane view and a side view showing the structure of a magnetic tape apparatus according to another prior art reference (No.1994-168524), respectively;

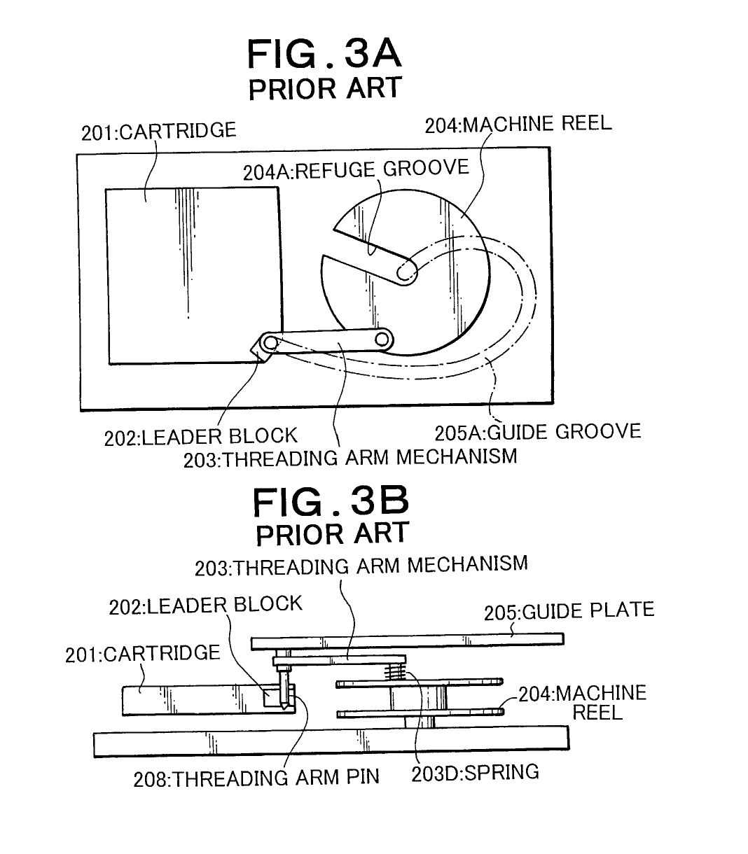

FIGS. 4A and 4B are a side view and a plane view showing the structure of a magnetic tape apparatus according to the present invention, respectively;

FIGS. 5A and 5B are a side view and a plane view showing the structure of a tape cartridge for use with the magnetic tape apparatus according to the present invention, respectively;

FIGS. 6A and 6B are schematic diagrams for explaining an operation for inserting the tape cartridge into the magnetic tape apparatus;

FIGS. 7A, 7B, and 7C are schematic diagrams for explaining an operation of a leader block performed after the tape cartridge has been inserted into the magnetic tape apparatus; and

FIGS. 8A, 8B, 8C, 8D, 8E, and 8F are schematic diagrams for explaining operations of a drive arm, a follower arm, and the leader block performed as the reel is rotated.

### DESCRIPTION OF PREFERRED EMBODIMENT

Next, with reference to the accompanying drawings, an embodiment of the present invention will be described.

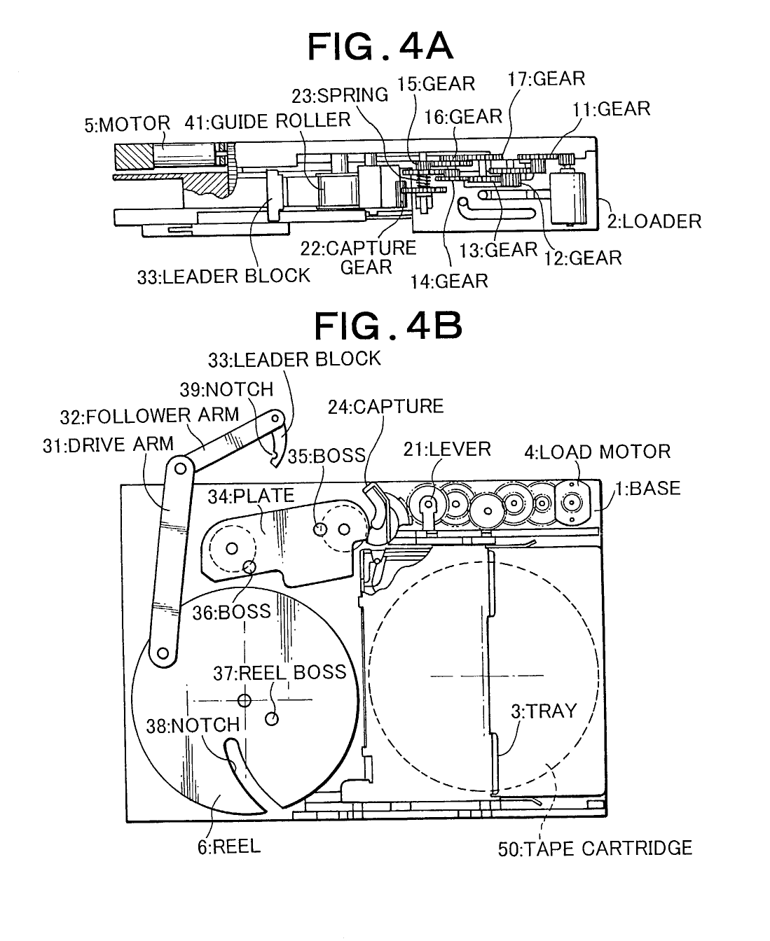

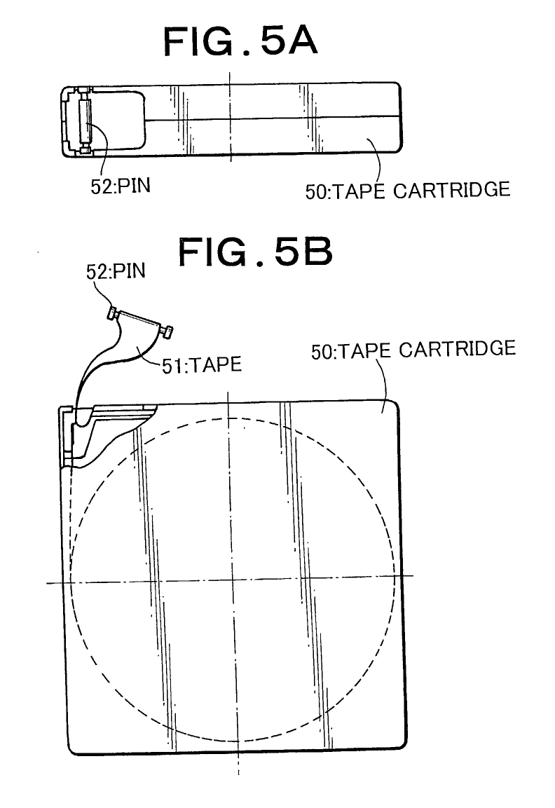

FIGS. 4A and 4B are a side view and a plane view showing the structure of a magnetic tape apparatus according to the present invention, respectively. FIGS. 5A and 5B are a side view and a plane view showing the structure of a tape cartridge for use with the magnetic tape apparatus according to the present invention. The tape cartridge is denoted by reference numeral 50. The tape cartridge 50 contains a tape 51 on which data is magnetically recorded. A pin 52 is disposed at a tip of the tape 51. The pin 52 is used to pull out the tape 51 from the tape cartridge 50.

With reference to FIGS. 4A and 4B, the magnetic tape apparatus according to the present invention has a loader 2 that places the tape cartridge 50 on a base 1. The base 1 has a reel 6 and a motor 5. The tape 51 is wound around the reel 6. The motor 5 rotates the reel 6. A drive arm 31 is disposed on the reel 6. The drive arm 31 pulls out the tape 51 from the tape cartridge 50. A follower arm 32 is disposed on the drive arm 31. A leader block 33 is disposed at a tip of the follower arm 32. The leader block 33 catches the pin 52. The leader block 33 is rotatable to the follower arm 32. The leader block 33 has a notch 39 with which the pin 52 is hooked.

The reel 6 has a reel boss 37 that causes the drive arm 31 to stop above the reel 6. In addition, the reel 6 has a notch 38 through which the leader block 33 is placed in the reel 6.

A load motor 4 is disposed on the base 1. The load motor 4 supplies a motive power to the loader 2. Gears 11 to 17 that transfer the motive power are disposed between the load motor 4 and the loader 2. As the load motor 4 is rotated, the loader 2 is moved. The loader 2 places the tape cartridge 50 inserted from the outside at a predetermined position on the base 1.

The loader 2 has a tray 3 that supports the tape cartridge 50. The tray 3 is moved upwardly and downwardly so that the tape cartridge 50 is placed on the base 1. The tray 3 has a lever 21 that is upwardly and downwardly moved together therewith.

As the lever 21 is upwardly and downwardly moved, a capture gear 22 is upwardly and downwardly moved together therewith. When the tape cartridge 50 is placed on the base 1, the capture gear 22 is engaged with the gear 15 so that the motive power of the load motor 4 is transferred to the capture gear 22. A spring 23 is disposed between the capture gear 22 and the gear 15. Only when the lever 21 is moved, the spring 23 causes the capture gear 22 and the gear 15 to be engaged. A capture 24 is connected to the capture gear 22. The capture 24 causes the leader block 33 to be rotated.

Two guide rollers 41 are disposed on the base 1. The guide rollers 41 guide the tape 51. A plate 34 is disposed above the guide roller 41. Bosses 35 and 36 are disposed above the plate 34. The bosses 35 and 36 guide the drive arm 31 and the follower arm 32.

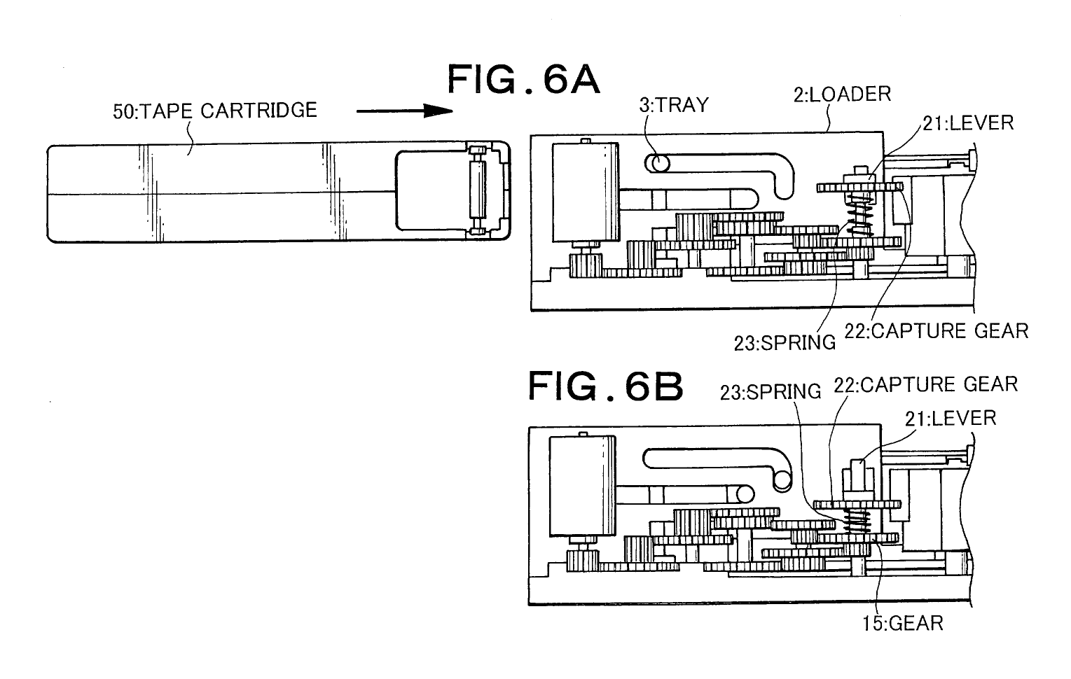

FIGS. 6A and 6B show an operation of which the tape cartridge is inserted into the magnetic tape apparatus. When the tape cartridge 50 is inserted into the loader 2 as shown in FIG. 6A, the tray 3 is moved toward the base 1 and the tape cartridge 50 is placed on the base 1 as shown in FIG. 6B. At that point, the lever 21 is moved toward the base 1 together with the tray 3. The lever 21 pushes the capture gear 22 to be engaged with the gear 15. At that point, the spring 23 is disposed between the capture gear 22 and the gear 15, and the spring 23 causes the capture gear 22 to be disengaged from the gear 15 as the tray 3 is left from the base 1.

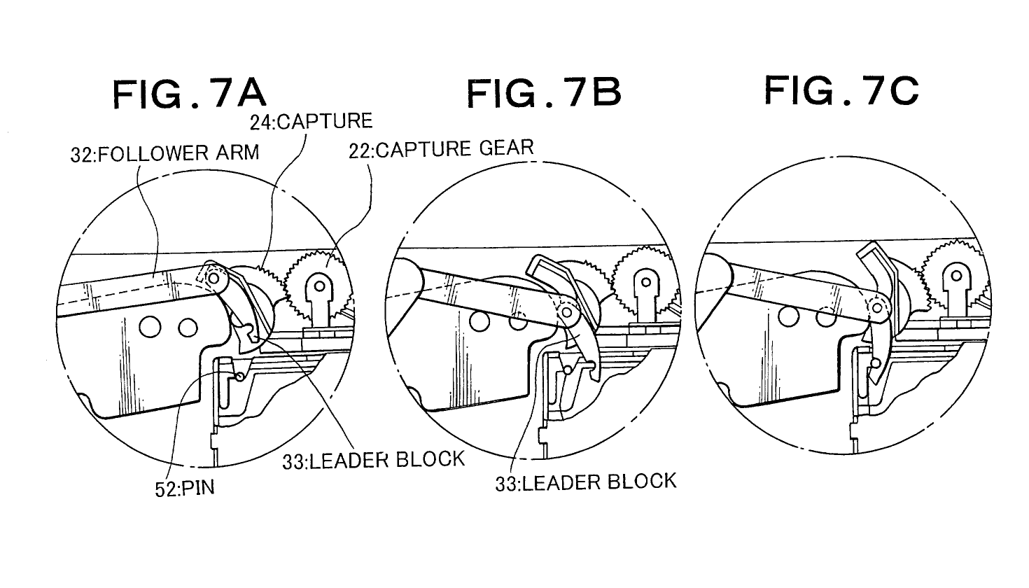

FIGS. 7A, 7B, and 7C show an operation of the leader block performed after the tape cartridge has been inserted into the magnetic tape apparatus. When the tape cartridge 50 is placed on the base 1, the reel 6 is rotated counterclockwise by the motor 5. As a result, the drive arm 31 and the follower arm 32 are moved. The drive arm 31 and the follower arm 32 cause the leader block 33 to be pushed from a state shown in FIG. 7A to a state shown in FIG. 7B. Thereafter, the capture gear 22 causes the capture 24 to be rotated and the leader block 33 to be rotated. As a result, the pin 52 is placed in the notch 39 in a state shown in FIG. 7C.

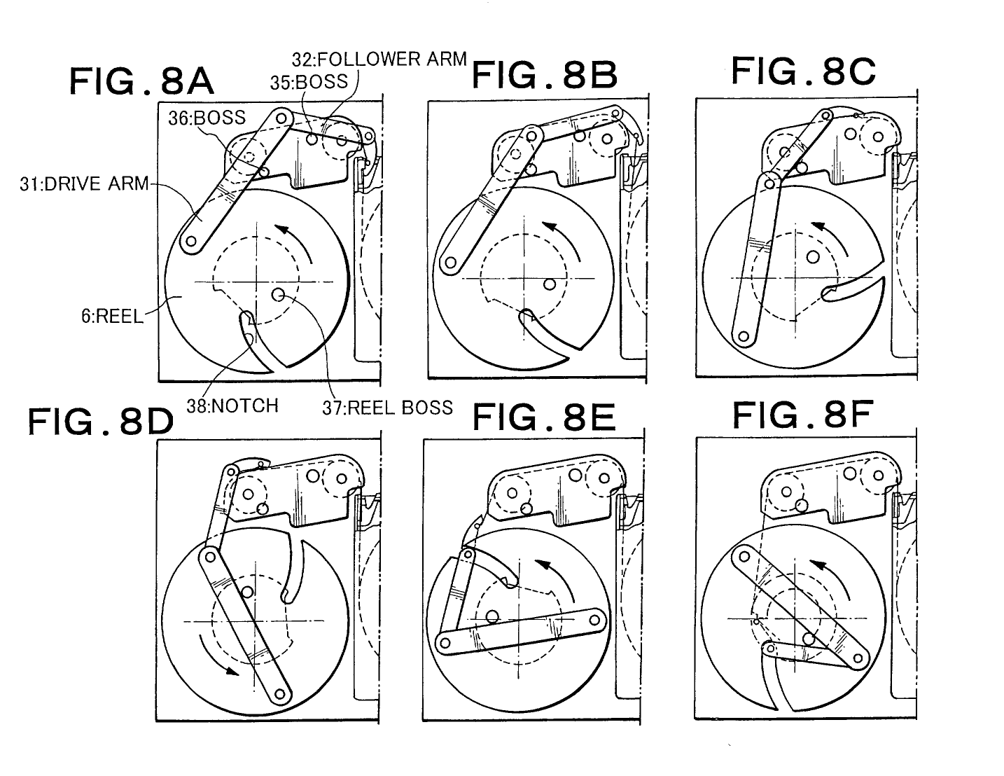

FIGS. 8A, 8B, 8C, 8D, 8E, and 8F show operations of the drive arm, the follower arm, and the leader block performed as the reel is rotated. In states shown in FIGS. 8A to 8C, the tape 51 is tensioned. The reel 6 is rotated counterclockwise. As a result, the drive arm 31 is guided by the boss 36, and the follower arm 32 contacts the boss 35. As a result, the leader block 33 is pulled out from the tape cartridge 50. As the reel 6 is further rotated, the drive arm 31 contacts the reel boss 37 in a state shown in FIG. 8D. The drive arm 31 is guided by the reel boss 37. The leader block 33 is placed in the notch 38 in a state shown in FIG. 8E, and is placed in the reel 6 in a state shown in FIG. 8F. As the reel 6 is further rotated, the tape 51 is wound around the reel 6.

When the tape 51 is returned to the tape cartridge 50, the reel 6 is rotated clockwise. The drive arms 31 and 32 are moved by means of the tension of the tape 51 in the states as shown in FIGS. 8F to 8A. As a result, the tape 51 and the pin 52 are returned to the tape cartridge 50. Thereafter, the capture 24 is rotated by the load motor 4 in the states shown in FIGS. 7C to 7B. Thereafter, as the reel 6 is rotated counterclockwise, the leader block 33 is discharged from the tape cartridge 50.

As was described above, as the motor 5 is rotated, the drive arm 31 and the follower arm 32 are rotated together with the reel 6. The leader block 33 causes the tape 51 to be pulled out from the tape cartridge 50. As a result, the tape 51 can be wound around the reel 6.

As was described above, as a first effect of the present invention, since the motor for rotating the reel is used as a motive power source for the arm, no extra motive power for pulling out the tape is required. As a result, the cost and size of the apparatus can be reduced.

As a second effect, a path for a motive power from the motor is simple. In addition, the arm can be supported by the reel. Thus, the shape of the arm is simple. In addition, the number of parts becomes small. Consequently, the assembling operations can be easily performed. As a result, the reliability of the apparatus is improved. In addition, the cost of the apparatus can be reduced.

As a third effect, since a path for a motive power from the motor is simple, time necessary for pulling out the tape is short. Thus, time after the tape cartridge is inserted into the apparatus until data is accessed becomes short.

Although the present invention has been shown and described with respect to a preferred embodiment thereof, it should be understood by those skilled in the art that the foregoing and various other changes, omissions, and additions in the form and detail thereof may be made therein without departing from the spirit and scope of the present invention.

What is claimed is:

1. A magnetic tape apparatus for performing magnetic recording and reproducing operations using a tape cartridge containing a magnetic tape having a lead pin disposed at a tip thereof, said apparatus comprising:
a reel around which the tape is wound;
a motor for rotating the reel;
a drive arm disposed on the reel;
a follower arm rotatably disposed at a tip of the drive arm; and
a leader block rotatably disposed on the follower arm, said leader block having a notch for hooking the pin.

2. The magnetic tape apparatus as set forth in claim 1, said apparatus further comprising:
a base on which the tape cartridge is placed;
a loader for placing the tape cartridge on the base; and
a load motor for supplying a motive power to the loader, said load motor causing the loader to be moved and the inserted tape cartridge to be placed at a predetermined position of the base.

3. The magnetic tape apparatus as set forth in claim 2,
wherein the loader has:
a tray for supporting the tape cartridge;
a lever moving upwardly and downwardly together with the tray;
a capture gear moving upwardly and downwardly together with the lever; and
a capture, connected to the capture gear, for rotating the leader block,
wherein the motive power is transferred from the load motor to the capture gear, when the tape cartridge is placed on the base.

4. The magnetic tape apparatus as set forth in claim 3,
wherein the motor causes the reel to be rotated, the drive arm and follower arm to be rotated, and the leader block to be plunged into the tape cartridge, when the tape cartridge is placed on the base.

5. The magnetic tape apparatus as set forth in claim 4 ,
wherein the load motor causes the capture to be driven, the leader block to be rotated, and the pin to be placed in the notch, when the leader block is plunged into the tape cartridge.

6. The magnetic tape apparatus as set forth in claim 5,
wherein the reel has a notch for holding the leader block, and
wherein the motor causes the drive arm and follower arm to be rotated together with the reel, the leader block to be pulled out from the tape cartridge, the leader block to be placed in the leader block, and the tape to be wound around the reel, as the motor is rotated.
